(19) United States
(12) Patent Application Publication
(10) Pub. No.: US 2011/0091677 A1
(43) Pub. Date: Apr. 21, 2011

(54) Data Sheet for An ID

(75) Inventors: Stefan Egli, Basel (CH); Urs Fawer, Baden (CH)

(73) Assignee: TRUB AG, Aarau (CH)

(21) Appl. No.: 12/898,170

(22) Filed: Oct. 5, 2010

(30) Foreign Application Priority Data
Oct. 20, 2009 (DE) 202009013388.5

(51) Int. Cl. B42D 15/10; G09F 3/02; B32B 3/02

(52) U.S. Cl. 428/43

(57) ABSTRACT

The data sheet comprises a plate (2) which is or can be personalized on at least one side. The plate (2) can be bound into the ID with a strip-shaped flexible connecting element (3). By means of a connection (5), the connecting element (3) is firmly connected to one edge (4) of the plate (2). The strip-shaped connecting element (3) has at least one weakened material portion (6) which makes it more difficult to detach the plate (2) from the connecting element (3) without damage. The weakened material portion (6) is, for example, an incision or a score in the connecting element (3). The invention increases the security against forgery of IDs which have such a data sheet (1).

The invention relates to a data sheet for an ID, for example a passport booklet, comprising a plate which is or can be personalized on at least one side, and comprising a strip-shaped flexible connecting element with which the plate can be bound into a document, for example a passport booklet, and which is firmly connected to one edge of the plate by means of a connection.

A data sheet of this type is known in the prior art, for example from EP 1 502 765 A from the Applicant. Such data pages are increasingly used for the production of high-quality passport booklets. The plate, which is generally personalized with an image and data about the holder, generally consists of a comparatively stiff thermoplastic material, for example polycarbonate. Above a certain thickness, such a plate cannot be bound directly into the passport booklet. In order to bind the said plate in, a strip-shaped flexible connecting element or binding tab is therefore provided. The connecting element is firmly connected to the plate by means of lamination. A particularly firm connection is ensured if the connecting element is formed as a textile, apertures in the mesh forming connecting elements.

EP 1 592 565 B discloses a data sheet in which the connecting element is provided with openings, by means of which connecting points are created during the lamination of overlapping sheets.

EP 1 008 459 A discloses a data sheet in which the plate is likewise bound in with a strip-shaped flexible connecting element. The flexible connecting element has punched-out portions through which in each case a pin of a connecting bar engages.

In the case of such a data sheet, forgeries are conceivable in which, in the case of a passport booklet, the plate is separated from the strip-shaped flexible connecting element. The separated plate is then replaced by another. In the case of the data pages according to the aforementioned prior art, this is made more difficult by the strip-shaped and flexible connecting element being connected as intimately as possible to the plate.

The invention is based on the object of devising a data page of the said type which makes the said possibility of forgery even more difficult.

According to claim 1, the invention is achieved in that the strip-shaped connecting element has at least one weakened material portion which makes it more difficult to detach the plate from the connecting element without damage.

An attempt at forgery is successful only when the plate can be detached without damaging the connecting element. By means of the weakened material portions provided in the data sheet according to the invention, this is made considerably more difficult. When the plate is detached, it is barely possible to avoid forces being exerted on the connecting element. These then result in the connecting element tearing at the weakened material portions and thus forming tears, which from time to time would be immediately visible on the forged passport booklet. It would therefore not be possible to use a passport booklet comprising a plate which has been replaced. It has been shown that such weakened material portions are possible without the normal use of such a passport booklet being impaired. Despite these weakened material portions, the plate can thus be used in the usual way. The weakened material portions tear only when an attempt is made to separate the plate from the connecting element.

According to a development of the invention, the at least one weakened material portion is implemented by means of an incision or a score in the connecting element. Such incisions or scores can be incorporated in the connecting element in a straightforward manner. A plurality of such weakened material portions are preferably provided. These weakened material portions can be arranged in a row along the edge of the plate.

According to a development of the invention, provision is made for at least one weakened material portion to be arranged in the region of the connection. During the attempt to separate the plate from the connecting element, it is not possible to avoid the weakened material portion being affected. Security is particularly high when, according to a development of the invention, the at least one weakened material portion is arranged partly in the region of the connection and partly outside the connection and thus in a visible region. However, a design in which the at least one weakened material portion is located completely in the region of the connection and is not visible from outside is also possible.

According to a development of the invention, provision is made for at least one weakened material portion to be formed in the shape of a cross. In the event of an attempt at manipulation, such a weakened material portion leads particularly quickly to a tear in the connecting element, which would then be detectable from time to time. It is also possible for a plurality of such cross-shaped cuts or scores to be provided.

In the case of the data sheet according to the invention, the connecting element is preferably connected to the plate by means of lamination. However, this is not imperative. In principle, the connecting element could also be adhesively bonded to the plate. A mechanical connection is also conceivable.

The connecting element can be a thin sheet, for example a plastic film, or else a textile. Security is particularly high when the connecting element is formed as a textile. In the event of an attempt at forgery, it is then barely possible to avoid the threads of the textile tearing, on account of the weakened material portion. However, torn threads can barely be repaired and would be simply detectable from time to time on the forged passport booklet.

Further advantageous features emerge from the dependent patent claims, the following description and the drawing.

Exemplary embodiments of the invention will be explained in more detail below by using the drawings, in which:

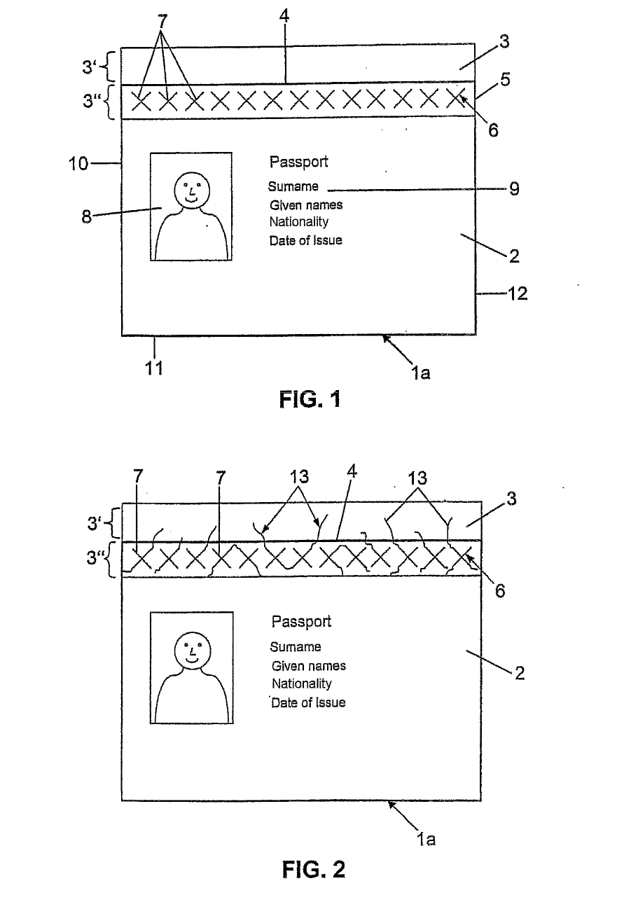

FIG. 1 shows a view of a data sheet according to the invention,

FIG. 2 shows a view of the data sheet according to FIG. 1 but after an attempt at forgery,

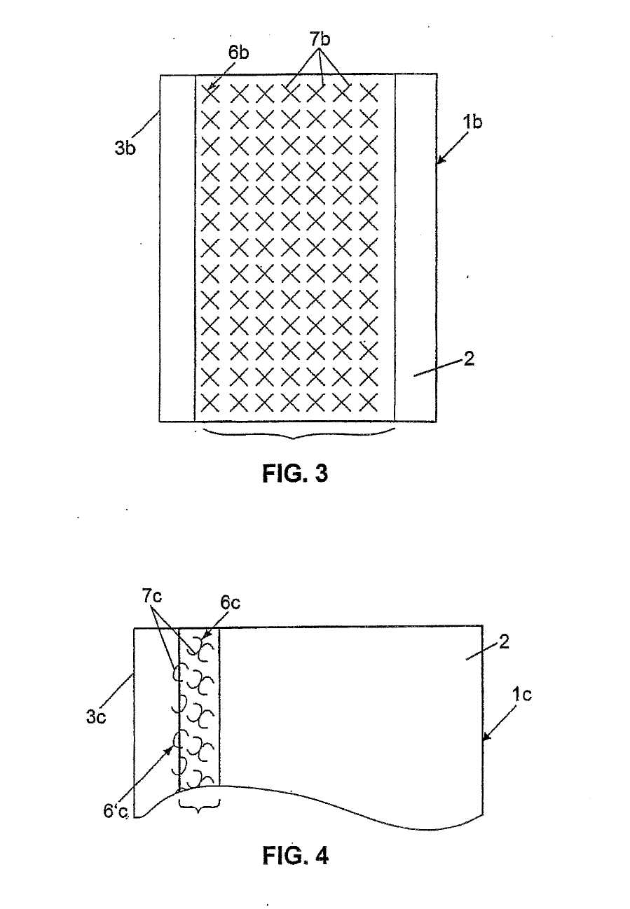

FIG. 3 shows a view of an alternative embodiment of the data sheet according to the invention, and

FIGS. 4 to 8 show sections of data sheets according to the invention according to variants.

The data sheet 1a shown in FIG. 1 has a comparatively stiff plate 2, which is firmly connected to a connecting element 3. The plate 2 consists of polycarbonate, for example, and is personalized with an image 8 and data 9 of the holder. The connecting element 3 is a thin sheet or a textile, for example a fabric, and is flexible. At this connecting element 3, the data sheet 1 is bound into the booklet, not shown here. The connection 5 preferably extends over the entire length of one edge 4 and thus from a lateral free edge 10 to a parallel opposite free edge 12. The edge 4 is parallel to a further edge 11. The connection 5 is, for example, an adhesive connection, a welded connection or can also be a mechanical connection. The connecting element 3 has a first strip-shaped region 3′, which is located outside the plate 2, and a further likewise strip-shaped region 3″, which is located in the region of the plate 2 and forms the connection 5. In this region 3″, a weakened material portion 6 is incorporated into the connecting element 3. The said portion consists of a plurality of weakening elements 7 which, as can be seen, are arranged in a row. These weakening elements 7 are incisions or scores in the connecting element 3. As can be seen, these are formed in the shape of crosses. A weakening element 7 thus consists of two crossing incisions or scores.

If an attempt is now made to detach the plate 2 from the connecting element 3, separation forces which act on the connecting element 3 in the region of the connection 5 cannot be avoided. This leads almost inevitably to the connecting element tearing in the region of at least one weakening element 7. Such a tear propagates in the connecting element 3 and ultimately, according to FIG. 2, becomes visible in the region 3′. FIG. 2 shows such tears 13, which extend from the region 3″ into the region 3′. Even if the plate 2 can finally be detached from the connecting element 3, such a passport booklet is no longer usable, since the damage to the connecting element 3 would be immediately detectable. Following the replacement of the plate, it would immediately be possible to detect on the passport booklet that manipulation had taken place.

FIG. 3 shows a data sheet 1b in which a connecting element 3b extends substantially over the entire area of the plate 2. Accordingly, very many weakening elements 7b are possible here, which form a weakened material portion 6b which extends substantially over the entire area of the plate 2.

FIG. 4 shows a data sheet 1c in which a weakened material portion 6c is provided which consists of C-shaped weakening elements 7c. Some of the weakening elements 7c are located completely in the region of the plate 2, while others are located partly in the region of the plate and in the region outside this plate. A connecting element 3c provided here is thus provided with weakening elements 7c only in a small subregion in the projecting region.

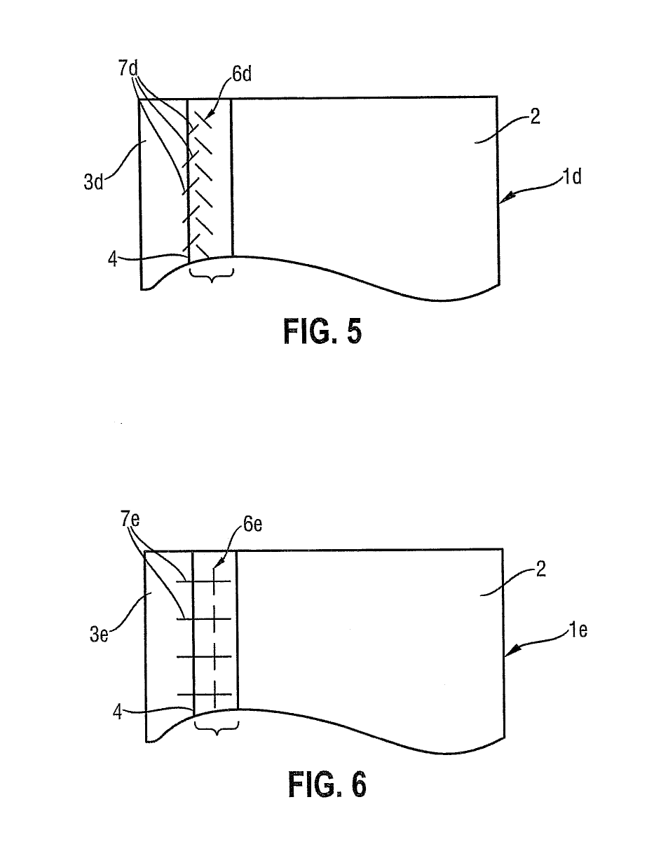

In the case of the data sheet 1d shown in FIG. 5, a weakened material portion 6d is provided which consists of weakening elements 7d which are individual cuts or scores. Here, too, the connecting element 3d is provided with incisions or scores only in a transition region of the projecting part.

The data sheet 1e shown in FIG. 6 has a weakened material portion 6e which is formed by weakening elements 7e which are likewise formed in the shape of crosses. In each case, an incision or a score of the weakening element 7e extends from the region of the plate 2 into the region of a connecting element 3e located outside this plate.

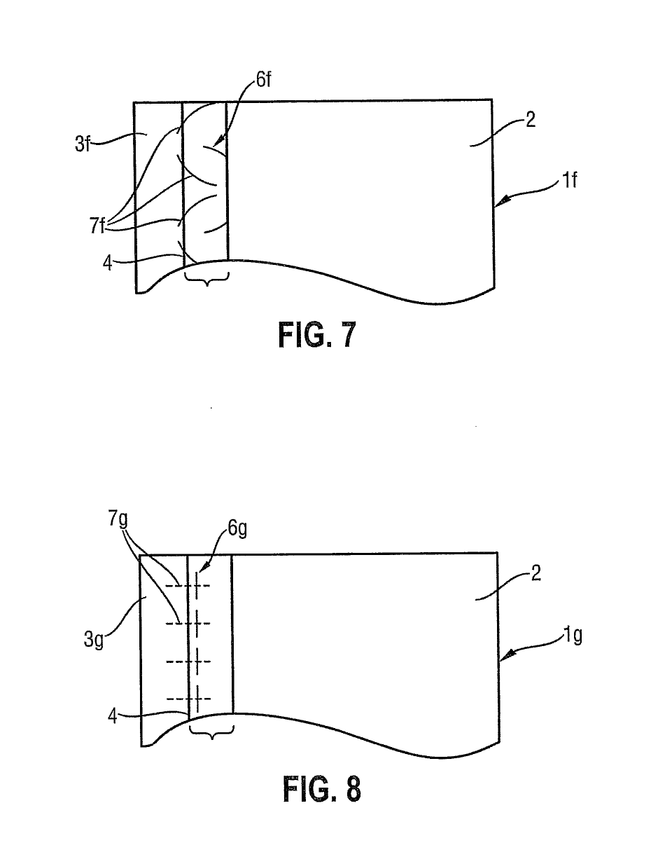

FIGS. 7 and 8 show data sheets 1f and 1g which exhibit weakened material portions 6f and 6g with alternative weakening elements 7f and 7g. The corresponding connecting elements 3f and 3g are likewise provided with incisions or scores in the region of the plate and outside this region.

Incisions and scores are merely examples as to how such weakened material portions 6 or weakening elements 7 can be implemented. In principle, for example, it would also be conceivable in the case of a textile or fabric to use threads which are weakened in at least one region and which in principle have a particularly low tearing force. In the event of an attempt at detachment, these threads then tear, which means that the connecting element 3 is visibly changed. It is important that the weakened material portion 6 or 6a to 6g does not impair the connection between the connecting element 3 and the plate 2 and also the passport booklet can otherwise be used as usual.

### LIST OF REFERENCE SYMBOLS

1 Data sheet
2 Plate
3 Connecting element
4 Edge
5 Connection
6 Weakened material portion
7 Element
8 Image
9 Data
10 Edge
11 Edge
12 Edge
13 Tear

1-15. (canceled)

16. A data sheet for an ID comprising a plate capable of being personalized on at least one side, and comprising a strip-shaped flexible connecting element with which the plate can be bound into the ID, and which is firmly connected to one edge of the plate by means of a connection, wherein the strip-shaped flexible connecting element has at least one weakened material portion which makes it more difficult to detach the plate from the connecting element without damage.

17. A data sheet according to claim 16, wherein the at least one weakened material portion is an incision or a score in the connecting element.

18. A data sheet according to claim 16, wherein the at least one weakened material portion has a plurality of weakening elements.

19. A data sheet according to claim 16, wherein the at least one weakened material portion is arranged in the region of the connection.

20. A data sheet according to claim 19, wherein the at least one weakened material portion is arranged partly in the region of the connection and partly outside the connection.

21. A data sheet according to claim 16, wherein the at least one weakened material portion is arranged completely outside the connection.

22. A data sheet according to claim 16, wherein the at least one weakened material portion has at least one weakening element which is formed in the shape of a cross.

23. A data sheet according to claim 22, wherein the cross-shaped weakening element is formed by two crossing cuts or scores.

24. A data sheet according to claim 16, wherein the at least one weakened material portion has at least one weakening element which has an incision or a score which is partly arranged in the region of the connection and partly outside the connection.

25. A data sheet according to claim 16, wherein the connection is an adhesive connection, a welded connection, a connection by means of lamination or a mechanical connection.

26. A data sheet according to claim 25, wherein the plate has at least two parts connected to each other by lamination.

27. A data sheet according to claim 16, wherein the at least one weakened material portion is partly or completely invisible.

28. A data sheet according to claim 16, wherein the connecting element is a thin sheet or a textile.

29. A data sheet according to claim 28, wherein the connecting element is a fabric.

30. A data sheet according to claim 16, wherein the plate is produced from polycarbonate.
